(19) United States
(12) Patent Application Publication
(10) Pub. No.: US 2019/0174045 A1
(43) Pub. Date: Jun. 6, 2019

(54) CONTROL METHOD FOR SURVEILLANCE SYSTEM

(71) Applicant: GETAC TECHNOLOGY CORPORATION, Hsinchu County (TW)

(72) Inventor: Tien-Fang LIAO, Taipei City (TW)

(21) Appl. No.: 16/033,147

(22) Filed: Jul. 11, 2018

(30) Foreign Application Priority Data
Dec. 1, 2017 (TW) 106142291

(51) Int. Cl. H04N 5/235; G08B 13/196; G08B 13/191; H04N 7/18

(52) U.S. Cl. CPC H04N 5/2351; G08B 13/19602; H04N 7/183; H04N 5/2354; G08B 13/191

(57) ABSTRACT

A control method for surveillance system includes the steps of: detecting a region of interest by an infrared sensor; generating a trigger signal by the infrared sensor when the infrared sensor detects a moving object in the region of interest; receiving the trigger signal by a controller and determining accordingly thereby whether to generate an enable command; taking pictures of the region of interest to generate an image thereof, by an infrared camera, when the infrared camera receives the enable command; receiving the image by the controller and determining accordingly thereby whether the image meets an illumination-related criterion; sending an illumination command by the controller when the image meets the illumination-related criterion; and emitting visible light by a lamp when the lamp receives the illumination command.

### CROSS-REFERENCE TO RELATED APPLICATIONS

This application claims priority from Taiwan Patent Application No. 106142291, filed on Dec. 1, 2017, the entire disclosure of which is hereby incorporated by reference.

### BACKGROUND OF THE INVENTION

### Field of the Invention

The present invention relates to control methods for surveillance systems and, more particularly, to a control method for a surveillance system, so as to trigger illumination in accordance with image detection.

### Description of the Prior Art

Sensor lights for use in conventional surveillance systems are mostly passive infrared sensors (PIR sensors). Pyroelectric sensing components of PIR sensors detect infrared radiation from moving objects which are at temperatures above absolute zero (0° Kelvin) and send signals to turn on illumination lamps, such as floodlights, or turn on alarms which generate a loud sound to deter intruders.

However, the PIR sensors often make wrong judgments because of interference from various heat sources, light sources or radio frequency radiation. Furthermore, infrared radiated from the human body is characterized by low penetrability and thus easily blocked by clothes; hence, the infrared remains undetected by the pyroelectric sensing components. Last but not least, if the ambient temperature of the PIR sensors approximates the human body's temperature, the sensitivity of the PIR sensors will decrease, which may even result in a short-term detection failure. Turning on illumination lamps or alarms wrongly by the surveillance systems because of wrong judgments made by the PIR sensors not only causes a waste of electric power unnecessarily, but also annoys security guards and owners of the surveillance systems.

### SUMMARY OF THE INVENTION

In view of the aforesaid drawbacks of the prior art, it is an objective of the present invention to provide a control method for a surveillance system, which involves using sensor-triggered illumination and infrared camera-enabled night vision to increase the correctness rate of triggering illumination by the surveillance system and reduce losses otherwise caused by wrong judgments made by sensors.

In an embodiment of the present invention, a control method for a surveillance system comprises the steps of: detecting a region of interest by an infrared sensor, followed by generating a trigger signal by the infrared sensor when the infrared sensor detects a moving object in the region of interest; receiving the trigger signal by a controller and determining accordingly thereby whether the trigger signal has persisted for a specified period of time; generating an enable command by the controller when the determination is affirmative; and taking pictures of the region of interest by an infrared camera when the infrared camera receives the enable command.

In another embodiment of the present invention, a control method for a surveillance system comprises the steps of: taking pictures of a region of interest and generating an image by an infrared camera; receiving the image by a controller and determining thereby whether the image meets an illumination-related criterion, followed by sending an illumination command by the controller when the image meets the illumination-related criterion; and emitting visible light by a lamp when the lamp receives the illumination command. The illumination-related criterion is that a feature block in the image is identical to a reference object in an image database.

In yet another embodiment of the present invention, a control method for a surveillance system comprises the steps of: detecting a region of interest by an infrared sensor, followed by generating a trigger signal by the infrared sensor when the infrared sensor detects a moving object in the region of interest; receiving the trigger signal by a controller and determining by the controller whether the trigger signal has persisted for a specified period of time and generating the enable command by the controller when the trigger signal has persisted for the specified period of time; taking pictures of the region of interest to generate an image thereof, by an infrared camera, when the infrared camera receives the enable command; receiving the image by the controller and determining accordingly thereby whether the image meets an illumination-related criterion, followed by sending an illumination command by the controller when the image meets the illumination-related criterion; and emitting visible light by a lamp when the lamp receives the illumination command.

In conclusion, a control method for a surveillance system according to the present invention has advantages as follows: an infrared camera takes pictures in low illumination to perform nocturnal image detection; determining whether an object is a target object, and then determining whether to turn on a light source; reduction in the number of actions triggered wrongly by a passive infrared sensor.

The description above about the disclosure of the present invention and the description below about the implementation of the present invention not only illustrate and explain the spirit and principles of the present invention but also give a further explanation of the claims of the present invention.

### BRIEF DESCRIPTION OF THE DRAWINGS

FIG. 1 is a function block diagram of a surveillance system according to an embodiment of the present invention;

FIG. 2 is a flowchart of a control method for a surveillance system according to an embodiment of the present invention;

FIG. 3 is a function block diagram of a surveillance system according to another embodiment of the present invention;

FIG. 4 is a flowchart of a control method for a surveillance system according to another embodiment of the present invention;

FIG. 5 is a function block diagram of a surveillance system according to yet another embodiment of the present invention; and

FIG. 6 is a flowchart of a control method for a surveillance system according to yet another embodiment of the present invention.

### DETAILED DESCRIPTION OF THE EMBODIMENTS

The fine structures and advantages of the present invention are sufficiently illustrated with embodiments below to allow persons skilled in the art to gain insight into the technical contents of the present invention and implement the present invention accordingly. Furthermore, persons skilled in the art readily understand related objectives and advantages of the present invention by making reference to the disclosure contained in the specification, claims, and drawings of the present invention. The embodiments below further explain the viewpoints of the present invention but are not intended to limit the scope of the present invention by any viewpoints.

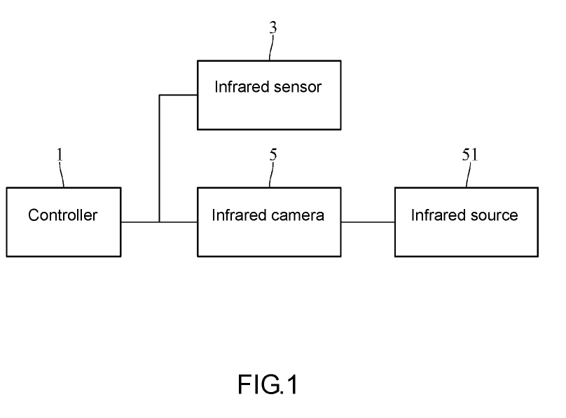

Referring to FIG. 1, a control method for a surveillance system according to an embodiment of the present invention is applicable to nocturnal picture-taking devices and mainly related to coordination between a controller 1, an infrared sensor 3 and an infrared camera 5. As shown in the diagram, the infrared sensor 3 and the infrared camera 5 are each electrically connected to the controller 1. In practice, the infrared sensor 3 is active or passive; hence, the present invention is not restrictive of the type of hardware for use in implementing the infrared sensor 3. The infrared camera 5 further comprises an infrared source 51 electrically connected to the infrared camera 5. The infrared source 51 is, for example, an infrared light-emitting diode (infrared LED), which provides an auxiliary light source to the infrared camera 5 in taking pictures at night.

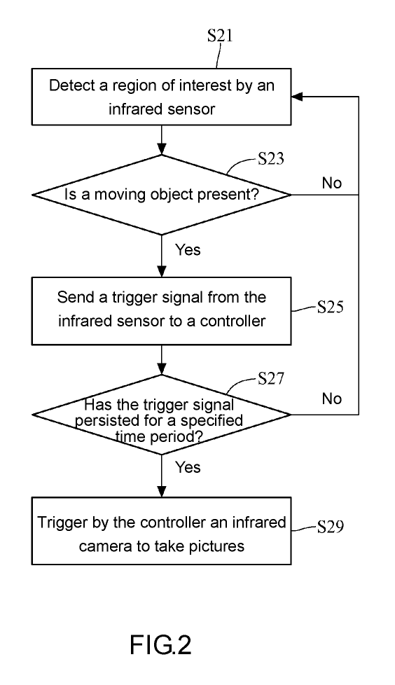

Referring to FIG. 2, a control method for a surveillance system according to an embodiment of the present invention comprises the steps described below. First, in step S21, the infrared sensor 3 detects a region of interest. The region of interest is a region which the infrared camera 5 takes pictures of. In steps S23-S25, when the infrared sensor 3 detects the presence of a moving object in the region of interest, it sends a trigger signal to the controller 1, otherwise the process flow of the control method goes back to step S21 so that the infrared sensor 3 continues detecting the region of interest. In step S27, the controller 1 is, for example, a microprocessor or a system on chip, which comprises a timer for measuring a period of time the trigger signal has persisted for. After the controller 1 has received the trigger signal, the controller 1 further determines whether the trigger signal has persisted for a specified period of time to ensure that a moving object is certainly present in the region of interest, and that the moving object has been moving for a period of time longer than the specified period of time. In step S29, after the trigger signal has persisted for a specified period of time, the controller 1 sends an enable command to instantly start the infrared camera 5 for taking pictures of the region of interest. Hence, negative effects of taking pictures continuously with an infrared camera for a long period of time, such as energy consumption, shortened service life of parts and components, and reduced available memory space, are eliminated, and the infrared camera is still able to generate required surveillance-oriented images. The infrared sensor 3 keeps detecting the region of interest while the infrared camera 5 is taking pictures; hence, the infrared camera 5 automatically stops taking pictures upon determination that the moving object is no longer present in the region of interest.

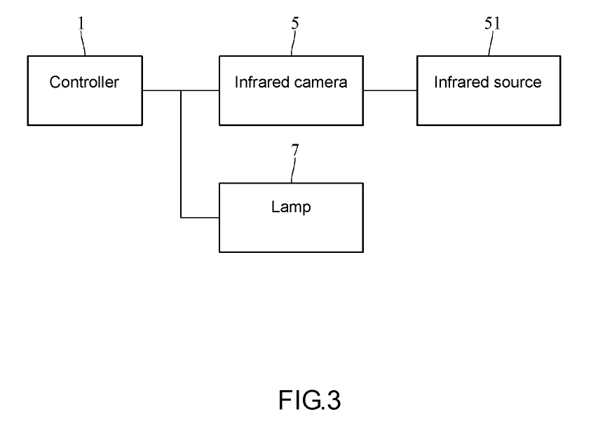

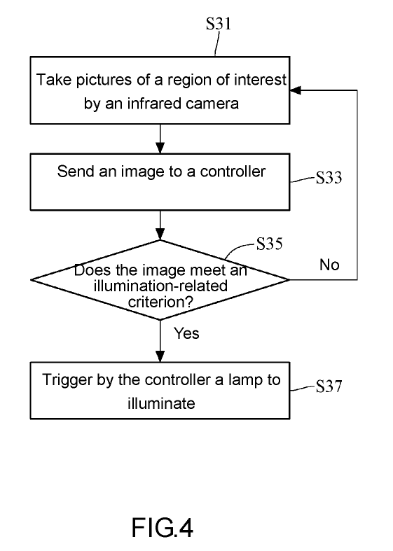

Referring to FIG. 3, a control method for a surveillance system according to an embodiment of the present invention is mainly related to coordination between a controller 1, an infrared camera 5 and a lamp 7. As shown in the diagram, the infrared camera 5 and the lamp 7 are each electrically connected to the controller 1. The infrared camera 5 further comprises an infrared source 51 electrically connected to the infrared camera 5. In practice, the lamp 7 is, for example, a light-emitting diode or any illumination apparatus capable of emitting visible light. Referring to FIG. 4, in step S31, the infrared camera 5 takes pictures of a region of interest. Since the control method is applicable to a surveillance system, the infrared camera 5 capable of night vision must be employed to meet the need for nocturnal surveillance. The infrared camera 5 has the infrared source 51 which emits infrared to illuminate a surveillance region while the infrared camera 5 is taking pictures. In step S33, the infrared camera 5 sends a generated image to the controller 1 for analysis. In step S35, the controller 1 sends an illumination command to the lamp 7 if the controller 1 determines that the generated image meets an illumination-related criterion. If the controller 1 determines that the generated image does not meet the illumination-related criterion, the process flow of the control method goes back to step S31 such that the infrared camera 5 keeps taking pictures in order to effectuate surveillance. In step S37, after receiving the illumination command, the lamp 7 emits visible light to further illuminate the surveillance region such that the infrared camera 5 generates sharp colored images.

In an embodiment of the present invention, the illumination-related criterion in step S35 is about determining whether a moving object is present in an image, for example, determining by the controller 1 whether two frames are identical according to images received in two consecutive instances. If the controller 1 finds different image blocks, the controller 1 determines that a moving object is present and repeats the aforesaid comparison process such that the trace of movement of the moving object can be drawn on the surveillance frames. To facilitate its use of the aforesaid illumination-related criterion, the controller 1 accesses human body's image samples stored in an image database. The image samples relate to parts of the human body, such as the head, the trunk, and the limbs, viewed from different angles and regarded as reference objects in an image. The controller 1 searches the image for a feature block identical to a reference object of the human body's image samples. If the controller 1 determines that a feature block in the image is identical to a reference object of the human body image samples, the controller 1 determines that a human being has entered the surveillance region and confirms that the illumination-related criterion is met; and then the controller 1 triggers visible light illumination to therefore increase the probability that images subsequently generated will be recognized. The control method of the present invention not only saves electric power otherwise consumed by the lamp 7 but also turns on a light, not on a regular basis, to deter intruders. Similarly, with the infrared camera 5 being engaged in taking pictures continuously and generating images, the controller 1 determines that no moving object is present in the region of interest and thus turns off the lamp 7 as soon as it confirms that the current frame of the region of interest is identical to an initial frame thereof.

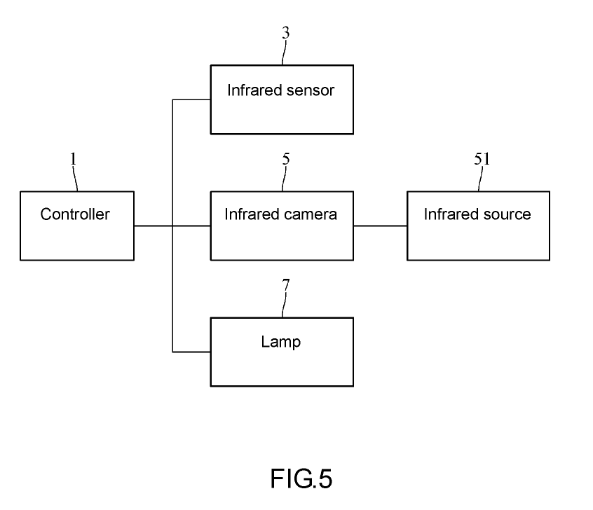

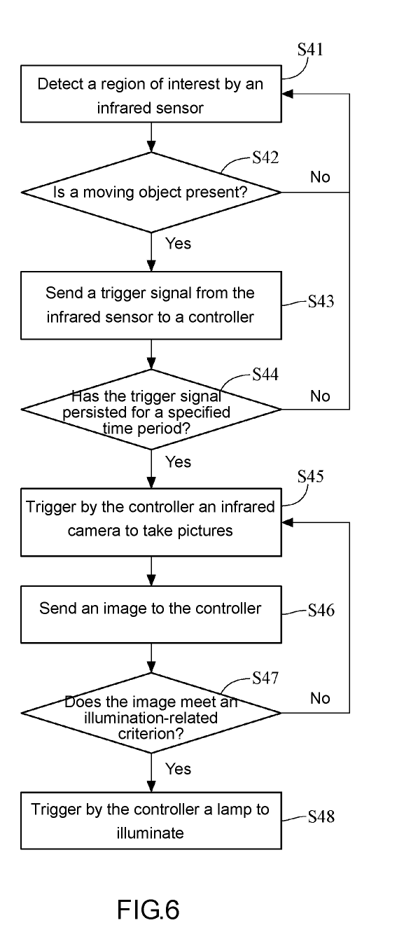

Referring to FIG. 5, a control method for a surveillance system according to an embodiment of the present invention is based on image detection-triggered illumination and mainly related to coordination between a controller 1, an infrared sensor 3, an infrared camera 5 and a lamp 7. As shown in the diagram, the infrared sensor 3, the infrared camera 5 and the lamp 7 are each electrically connected to the controller 1. The infrared camera 5 further comprises an infrared source 51 electrically connected to the infrared camera 5. Referring to FIG. 6, in steps S41-S43, the infrared sensor 3 detects a region of interest and sends a trigger signal to the controller 1 upon detection of a moving object in the region of interest. In steps S44-S45, the controller 1 determines whether to generate an enable command according to the period of time which the trigger signal has persisted for. However, in a variant embodiment, the controller 1 sends the enable command as soon as it receives the trigger command, and thus the present invention is not limited thereto. The infrared camera 5 begins taking pictures and generating an image as soon as it receives the enable command. Furthermore, not only does the infrared camera 5 taking pictures require much more electric power than the infrared sensor 3 detecting a region of interest, but images generated by the infrared camera 5 must also be stored in a storage device. To save electric power and optimize the memory capacity of the storage device, an embodiment of the present invention is characterized in that the infrared sensor 3 detects a region of interest on a preliminary basis, and, upon its detection of a moving object in the region of interest, the controller 1 starts the infrared camera 5 to confirm the detection of the moving object. In steps S46-S48, the infrared camera 5 sends a generated image to the controller 1, and then the controller 1 determines accordingly whether the image meets an illumination-related criterion. If the image meets the illumination-related criterion, the controller 1 turns on the lamp 7 for illumination; otherwise, the process flow of the control method goes back to step S45 to allow the infrared camera 5 to keep taking pictures and then allow the controller 1 to perform image recognition. In practice, the number of time the process flow of the control method goes from step S47 to step S45 is predetermined to prevent the infrared camera 5 from taking pictures unnecessarily for a long period of time which might otherwise cause a waste of electric power and memory space.

In an embodiment of the present invention, the illumination-related criterion of step S45 is the same as that of step S35, that is, either determining whether a moving object is present in an image or determining whether an image also relates to the human body with reference to an image database. In a variant embodiment of the present invention, the control method requires illumination-related criteria, for example, determining whether a moving object is present and determining whether a trigger signal is received. In another variant embodiment of the present invention, the illumination-related criteria include satisfaction of the aforesaid illumination-related criteria and detection by a photo sensor that the ambient brightness of the region of interest is lower than a predetermined brightness. Give strict illumination-related criteria, instances of illumination unnecessarily triggered because of wrong judgments made by the infrared sensor 3 are reduced. The present invention is further advantageous in that interference with the surveillance system as a result of a non-human factor is reduced.

Regarding the control method for a surveillance system according to another embodiment of the present invention, the region of interest to be detected comprises a first region and a second region. The first and second regions each have a lamp 7 for illumination. Hence, the illumination-related criteria are as follows: upon detection of a moving object in the first region, the controller 1 sends an illumination command for turning on the lamp 7 of the first region to effectuate illumination; and, if the moving object is moving from the first region to the second region or the moving object arrives at the second region, the controller 1 sends another illumination command for turning on the lamp 7 of the second region to effectuate illumination. In this embodiment, a moving object which has intruded into the region of interest is tracked and illuminated.

In conclusion, a control method for a surveillance system according to the present invention has technical features as follows: an infrared sensor starts an infrared camera and determines, by image recognition, whether to turn on a lamp to illuminate and thus assist with surveillance-oriented video recording; detect a moving object according to images generated by the infrared camera or detect a part of the human body, so as to precisely determine whether any person is present in a surveillance region; and, upon affirmative determination, trigger visible light illumination to assist the infrared camera in taking pictures precisely. The control method of the present invention has advantages as follows: eliminate the indefinite factor about making judgments with just an infrared sensor to therefore reduce unnecessary illumination interference; and start the infrared camera only upon completion of preliminary detection performed by the infrared sensor to therefore save electric power and memory space, thereby saving energy.

Although the present invention is disclosed above by embodiments, the embodiments are not restrictive of the present invention. Changes and modifications made by persons skilled in the art to the embodiments without departing from the spirit and scope of the present invention must be deemed falling within the scope of the claims of the present invention. Accordingly, the legal protection for the present invention shall be defined by the appended claims.

What is claimed is:

1. A control method for a surveillance system, comprising the steps of:
detecting a region of interest by an infrared sensor, followed by generating a trigger signal by the infrared sensor when the infrared sensor detects a moving object in the region of interest;
receiving the trigger signal by a controller and determining accordingly thereby whether to generate an enable command; and
taking pictures of the region of interest by an infrared camera when the infrared camera receives the enable command.

2. The control method for a surveillance system according to claim 1, further comprising, after the step of receiving the trigger signal by the controller, determining by the controller whether the trigger signal has persisted for a specified period of time and generating the enable command by the controller when the trigger signal has persisted for the specified period of time.

3. A control method for a surveillance system, comprising the steps of:
taking pictures of a region of interest and generating an image by an infrared camera;
receiving the image by a controller, determining by the controller whether the image meets an illumination-related criterion, and sending an illumination command by the controller when the image meets the illumination-related criterion; and
emitting visible light by a lamp when the lamp receives the illumination command.

4. The control method for a surveillance system according to claim 3, wherein the illumination-related criterion is that the controller compares a feature block in the image with a reference object in an image database and determines that the feature block is identical to the reference object.

5. A control method for a surveillance system, comprising the steps of:
detecting a region of interest by an infrared sensor, followed by generating a trigger signal by the infrared sensor when the infrared sensor detects a moving object in the region of interest;
receiving the trigger signal by a controller and determining accordingly thereby whether to generate an enable command;
taking pictures of the region of interest to generate an image thereof, by an infrared camera, when the infrared camera receives the enable command;
receiving the image by the controller and determining accordingly thereby whether the image meets an illumination-related criterion, followed by sending an illumination command by the controller when the image meets the illumination-related criterion; and
emitting visible light by a lamp when the lamp receives the illumination command.

6. The control method for a surveillance system according to claim 5, further comprising, after the step of receiving the trigger signal by the controller, determining by the controller whether the trigger signal has persisted for a specified period of time and generating the enable command by the controller when the trigger signal has persisted for the specified period of time.

7. The control method for a surveillance system according to claim 5, wherein the illumination-related criterion is presence of the moving object in the image signal.

8. The control method for a surveillance system according to claim 7, wherein the illumination-related criterion includes receipt of the trigger signal by the controller and presence of the moving object in the image signal.

9. The control method for a surveillance system according to claim 5, wherein the region of interest comprises a first region and a second region, and the illumination-related criterion is presence of the moving object in the first region.

10. The control method for a surveillance system according to claim 9, further comprising, after the step of sending the illumination command by the controller, determining by the controller whether the image meets another illumination-related criterion, wherein the another illumination-related criterion includes movement of the moving object from the first region to the second region and sending another illumination command by the controller when the image meets the another illumination-related criterion.

11. The control method for a surveillance system according to claim 10, wherein another lamp illuminates the second region, whereas the lamp illuminates the first region, allowing the another lamp to emit visible light after the lamp has emitted the visible light and as soon as the another lamp receives the another illumination command.

12. The control method for a surveillance system according to claim 5, wherein the illumination-related criterion further includes the controller's determination that a feature block in the image is identical to a reference object in an image database.

13. The control method for a surveillance system according to claim 5, wherein the illumination-related criterion is that ambient brightness of the region of interest is lower than a predetermined brightness.
